(19) United States
(12) Patent Application Publication
(10) Pub. No.: US 2013/0278468 A1
(43) Pub. Date: Oct. 24, 2013

(54) ARRANGEMENT OF MILLIMETER-WAVE ANTENNAS IN ELECTRONIC DEVICES HAVING A RADIATION ENERGY BLOCKING CASING

(71) Applicant: WILOCITY, Caesarea, IL (US)

(72) Inventors: Alon YEHEZKELY, Haifa (IL); Iddo DIUKMAN, Haifa (IL)

(73) Assignee: Wilocity, Caesarea, IL (US)

(21) Appl. No.: 13/865,718

(22) Filed: Apr. 18, 2013

Related U.S. Application Data
(60) Provisional application No. 61/635,989, filed on Apr. 20, 2012.

(51) Int. Cl. H01Q 1/24

(52) U.S. Cl. CPC H01Q 1/24
USPC 343/702

(57) ABSTRACT

A millimeter-wave active antenna array mounting apparatus is provided. The apparatus comprises a casing having at least one slit, wherein the casing is made of a radiation energy blocking material; and a millimeter-wave active antenna array configured to radiate millimeter-wave signals, wherein radiating elements of the millimeter-wave active antenna array are disposed corresponding to an opening of the at least one slit, thereby enabling an efficient radiation of the millimeter-wave signals through the casing.

### CROSS-REFERENCE TO RELATED APPLICATIONS

This application claims the benefit of U.S. Provisional Patent Application No. 61/635,989 filed on Apr. 20, 2012, the contents of which are incorporated herein by reference.

### TECHNICAL FIELD

The present invention relates generally to assembly and arrangement of antennas for transmitting and receiving millimeter wave signals in a computing device.

### BACKGROUND

The 60 GHz band is an unlicensed band which features a large amount of bandwidth and a large worldwide overlap. The large bandwidth means that a very high volume of information can be transmitted wirelessly. As a result, multiple applications, that require transmission of a large amount of data, can be developed to allow wireless communication around the 60 GHz band. Examples for such applications include, but are not limited to, wireless high definition TV (HDTV), wireless docking station, wireless Gigabit Ethernet, and many others.

In order to facilitate such applications there is a need to develop integrated circuits (ICs), such as amplifiers, mixers, radio frequency (RF) analog circuits, and active antennas that operate in the 60 GHz frequency range. Such circuits should be fabricated as a chip that can be assembled on a printed circuit board (PCB). The size of the package may range from several to a few hundred square millimeters. In addition, there is a need to solve problems resulting from the current assembly of electronic devices, such as laptop computers, in order to enable efficient transmission and reception of millimeter wave signals.

A prime example for such a problem is illustrated in FIG. 1, which shows a typical assembly of a laptop computer 100 having radio transmission capabilities. A motherboard 110 of the computer 100 includes a RF module 120 that receives and transmits RF signals through a receive antenna 130 and a transmit antenna 140, which are located in the lid 150. Signals from the RF module 120 to the antennas 130 and 140 are transferred over wires 160. The motherboard 110 is assembled in the base part of the computer 100, cooled by cooling fans, therefore the RF module 120 is installed therein.

The assembly illustrated in FIG. 1 cannot be adapted to enable the integration of 60 GHz communication applications in consumer electronics products, primarily because transferring high frequency signals over the wires 160 significantly attenuate the signals. Increasing the power of the signals at the RF module 120 would require designing complex and expensive RF circuits for the module 120. Thus, such assembly is not feasible for commercial uses in consumer electronics products of 60 GHz communication applications.

Recent solutions have been proposed to include the RF module operating the 60 GHz in the lid of the of the laptop computer, while the base-band module is integrated in the base of the computer. An illustration of such an assembly is shown in FIG. 2.

A laptop computer 200 includes an RF system 210 for transmission and reception of millimeter wave signals. The form factor of the RF system 210 is spread between the base 202 and lid planes 205 of the laptop computer 200.

The RF system 210 includes two parts: a baseband module 220 and a RF module 230 respectively connected to the base plane 202 and the lid plane 205. The RF module 230 includes an RF circuitry and an array of transmit (TX)/receive (RX) active antennas. When transmitting signals, the baseband module 220 typically provides the RF module 230 with control, local oscillator (LO), intermediate frequency (IF), and power (DC) signals. The control signal is utilized for functions, such as gain control, RX/TX switching, power level control, sensors, and detectors readouts. Specifically, beam-forming based RF systems require high frequency beam steering operations which are performed under the control of the baseband module 220. The control typically originates at the baseband 220 of the system, and transfers between the baseband module 220 and the RF module 230.

The RF module 230 by means of the RF circuitry typically performs up-conversion, using a mixer (not shown) on the IF signal(s) to RF signals and then transmits the RF signals through the TX antenna according to the controller on the control signals. The power signals are DC voltage signals that power the various components of the RF module 230.

In the receive direction, the RF module 230 receives RF signals at the frequency band of 60 GHz, through the active RX antenna and performs, by means of the RF circuitry, down-conversion, using a mixer, to IF signals using the LO signals, and sends the IF signals to baseband module 220. The operation of the RF module 230 is controlled by the control signal, but certain control information (e.g., feedback signal) is sent back to the baseband module 220.

However, other than the RF module 230 and an array of active antennas, the assembly of the lid plane 205 typically also includes a cellular antenna to communicate with a cellular network, a Wi-Fi antenna to receive and transmit signals from an access point of a wireless local area network (WLAN), and one or two webcams. To avoid problems of signal interferences, the various antennas should be positioned at a predefined distance from each other, thereby constraining the possible arrangements of the antennas in the laptop computer.

In addition and most importantly, recent designs of the cases of laptop computers (also known as ultrabook computers) are being made of radiation energy blocking materials and the dimensions of the lid plane are small. Such an assembly also contributes to the signal interferences problem and prevents efficient energy radiation of signals.

The above noted problems in laptop computers are also applicable to other handheld computing devices, such as smart phones, tablet computers, and the like. In such devices the area for placing additional components, and in particular, millimeter wave antennas, are even more limited and their casing materials may prevent efficient radiation of signals.

It would be therefore advantageous to provide a solution that overcomes the above-noted deficiencies.

### SUMMARY

Certain embodiments disclosed herein include a millimeter-wave active antenna array mounting apparatus. The apparatus comprises a casing having at least one slit, wherein the casing is made of a radiation energy blocking material; and a millimeter-wave active antenna array configured to radiate millimeter-wave signals, wherein radiating elements of the millimeter-wave active antenna array are disposed corresponding to an opening of the at least one slit, thereby enabling an efficient radiation of the millimeter-wave signals through the casing.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a typical assembly of a laptop computer having radio transmission capabilities.

FIG. 2 a diagram illustrating the assembly of a laptop computer having radio transmission capabilities in the 60 GHz frequency band.

FIG. 3 is a schematic diagram of a lid of a laptop computer depicting optional positions of slits in accordance with one embodiment.

FIG. 4 shows an arrangement of a millimeter-wave active antenna array in a slit in a casing of a computing device.

FIG. 5 is a cross-section diagram of the lid illustrating the assembly of the RF module including an of millimeter-wave active antenna array according to one embodiment.

FIG. 6 is an exploded diagram illustrating the assembly of a RF module into a casing of a computing device according to one embodiment.

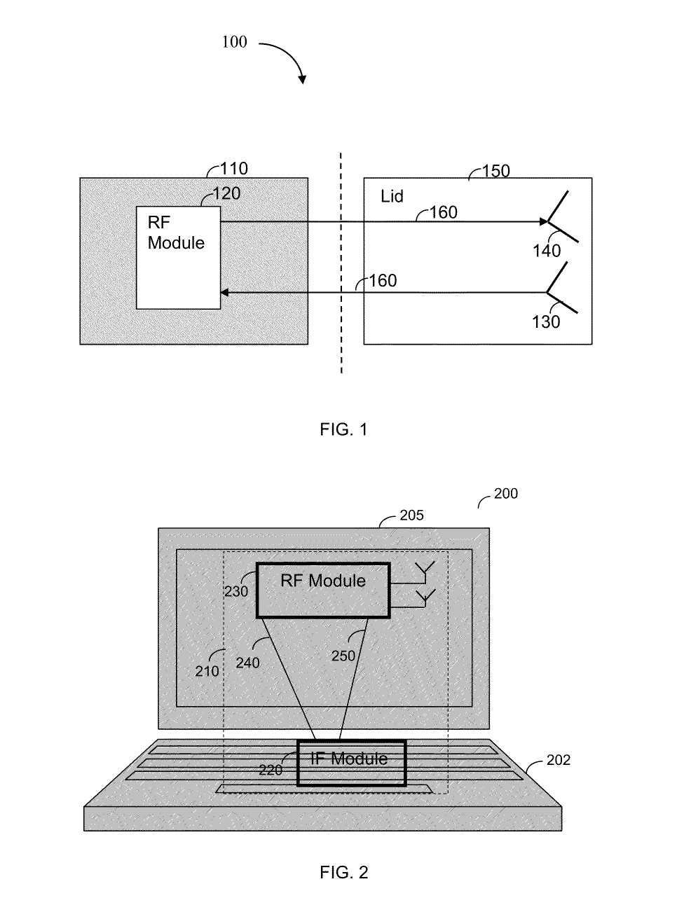

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

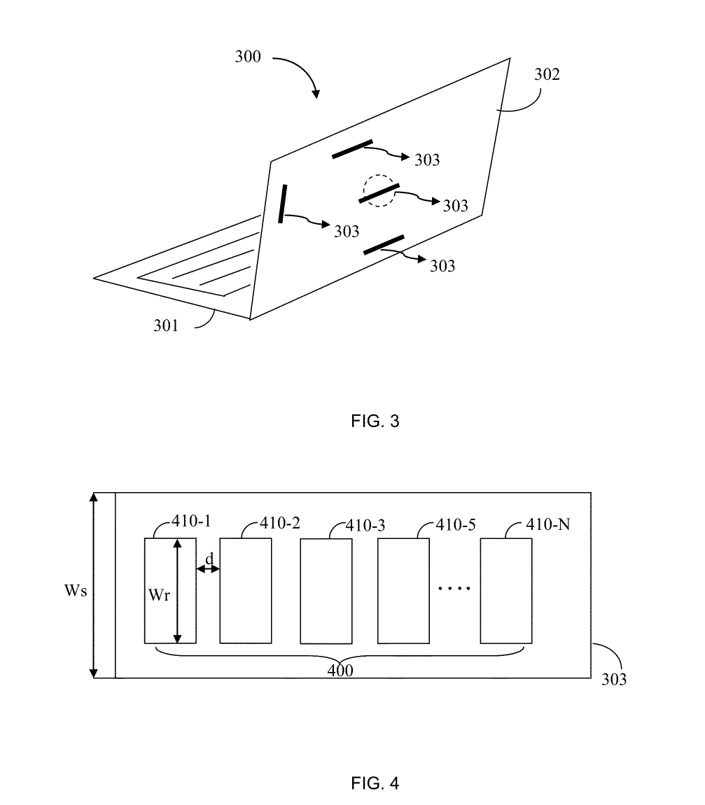

A schematic diagram of a laptop computer 300 assembled in accordance with one embodiment is shown in FIG. 3. The laptop computer 300 may be any handheld computer, such as a netbook, a notebook, an ultrabook, and the like. The case of the laptop computer 300 may be made of radiation energy blocking materials. The teachings disclosed herein can also be applied to other handheld computing devices, such as, but not limited to, smart phones, tablet computers, digital cameras, camcorders, and the like.

The form factor of a millimeter-wave RF system operable in the 60 GHz frequency band is speared between a base plane 301 and a lid 302 of the laptop computer 300. The base plane 301 includes a baseband module while the lid 302 includes the RF module and an array of millimeter-wave active antennas (not shown in FIG. 3). The connection between the RF and base-band modules and is by means of one cable. The functionalities of the RF and base-band modules and the signals transferred between them have been described above.

The casing of the lid 302 is made of radiation energy blocking materials, such as, carbon fibers, conductive metals, conductive metal fibers, or combinations thereof, therefore placing the RF module and the active antennas in the lid 302, being completely covered with radiation energy blocking material, would prevent RF signals from properly and efficiently propagating through the antennas. According to certain embodiments, one or more slits 303 are formed in the blocking material of the back of the lid 302. The radiating elements of the active antennas are assembled inside the lid 302 behind the slit(s), such that the radiating elements are not covered by the casing material of the lid 302.

Thus, locating the active antennas within the boundaries of a slit 303 would allow RF signals to be efficiently radiated without signal interferences. It should be noted that in the alternative, where the active antennas are covered by casing made of a radiation energy blocking material (e.g., metal), a “caging” effect is created, and as such RF signals cannot be efficiently radiated outside of the casing of the lid. Thus, the RF signals cannot be efficiently received and transmitted by the RF module. Whereas in the assembly of the active antennas in the slits 303, as disclosed herein, the RF signals can freely radiate through the slit.

In a preferred embodiment, the slit 303 may be placed in a top location for elevation which is beneficial for antenna coverage, a side location for ease of a cable routing or generation of a different antenna polarization, built into the notebook logo for minimal visual exposure, or at the back side of the lid's hinge for legacy component mounting techniques.

FIG. 4 shows an arrangement of a millimeter-wave active antenna array 400 in the slit 303. The active antenna array 400 include a plurality of radiating elements 410-1 through 410-N designed to support efficient reception and transmission of millimeter wave signals in at least the 60 GHz frequency band. According to one embodiment, the radiating elements 410 are implemented using metal patterns in a multilayer substrate of the RF module.

The radiating elements 410-1 through 410-N designed to support efficient reception and transmission of millimeter wave signals in at least the 60 GHz frequency band. The distance (d) between two elements (e.g., 410-1 and 410-2) is determined by the wavelength of the millimeter-wave signal. Typically, such distance is between a half wavelength and a full wavelength of a millimeter-wave signal. The width (Ws) of the slit 303 is a function of the width (Wr) of a radiating element. In an exemplary embodiment, the size (Ws) of the slit 303 when the active antenna 400 transmits/receives millimeter-wave signals is up to 1 mm. In another embodiment, the radiating elements 410-1 through 410-N may be placed in more than one slit 303.

The active antenna 400 may be a phased-array antenna in which each radiating element can be controlled individually to enable the usage of beam-forming techniques and to allow antenna diversity, for example, spatial diversity and/or polarization diversity. In another embodiment, the radiating elements 410 may be arranged as an end-fire array antenna. An end-fire array antenna radiates at the narrowest dimension of the RF module which includes the board and the RF circuitry. As a result, this requires a very narrow slit.

According to another embodiment, the millimeter-wave active antenna array 400 may be a triple-band antenna designed to receive and transmit millimeter wave signals in the WiFi bands of 2.4 GHz and 5 GHz as well as the 60 GHz frequency band. Such a triple-band antenna includes a printed antenna having two wings for transmitting and receiving low-frequency signals in any one of the 2.4 GHz and 5 GHz, and an antenna array including a plurality of radiating elements being printed on one of the wings of the printed antenna; the antenna array transmits and receives the 60 GHz band signals. An example of a triple-band antenna can be also found in a co-pending application 13/052,736, to Myszne, et al., assigned to the common assignee of the present application.

The radiating elements 410-1 through 410-N of the array of active antennas 400 are implemented using metal patterns in a multilayer substrate. Alternatively, the radiating elements 410-1 through 410-N can be mounted on the substrate. In certain implementations, the substrate of the RF module may be, but is not limited to, a PCB, a low temperature co-fired ceramic (LTCC), or any substrate material used for electronic modules.

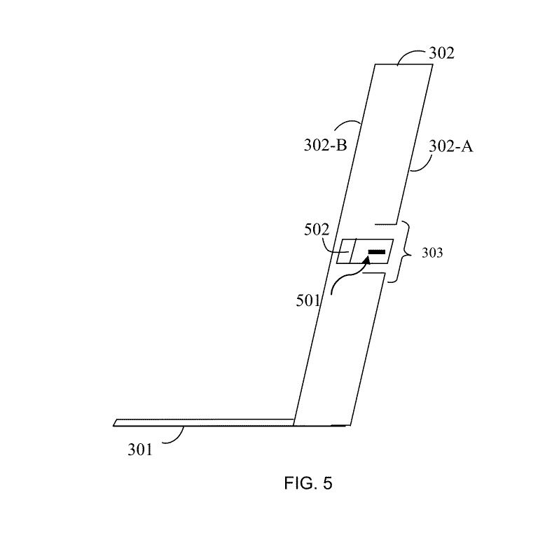

According to one embodiment illustrated in FIG. 5, a RF module 500 which the antenna's radiating elements are mounted or fabricated is inserted into the slit. This assembly can be beneficial in several ways, such as better radiation clearance, thermal solution, and as a mechanical holder.

FIG. 5 shows a cross-section diagram of the lid 302 illustrating the assembly of the millimeter wave active antenna array 501 in a slit 303. The RF module 500 includes a RF circuitry 502 and active antenna array 501 mounted on the substrate of the RD module 500. As noted above, the substrate of the RF module 500 may be, for example, a PCB, a LTCC, or any substrate material used for electronic modules.

The RF circuitry 502 processes signals received/transmitted by the active antenna array 501. The RF circuitry 502 typically performs up-conversion, using a mixer (not shown) on the IF signals received from base-band module to RF signals, and then transmits the RF signals through the TX antenna according to control signals also received from the base band module. In the receive direction, the RF module 502 receives RF signals at the frequency band of 60 GHz, through the active RX antenna, and performs down-conversion, using a mixer.

The RF module 500 is inserted in the slit 303 between the outer surface 302-A and inner surface of 302-A of the lid 302. The radiating elements of the antenna 501 are inside the slit 303 and exposed through an opening of the slit 303.

The RF module 500 may be also attached to the internal side of the casing of the outer surface 302-A having the radiating elements of the antenna 501 exposed externally through an opening of the slit 330. The RF module 500 is attached to the casing using adhesive material having thermal insulation properties. This embodiment can be utilized in devices that are not equipped with a lid (e.g., a tablet computer). The RF module 500 is attached to the casing, for example, a back panel of the device.

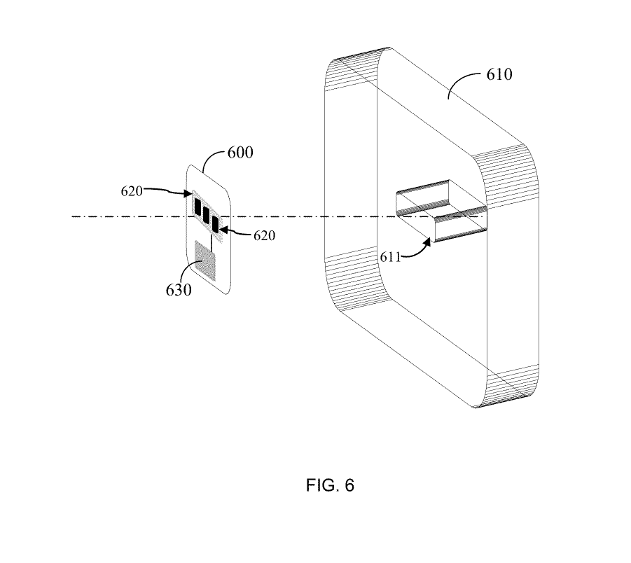

FIG. 6 is an exemplary and non-limiting exploded diagram of the assembly of a RF module 600 to a casing 610 of a computing device according to one embodiment. A millimeter-wave array of active antennas 620 and a RF circuitry 630 are mounted on a substrate of the RF module 600. The casing 600 is made of RF radiation energy blocking materials, such as, but not limited to, carbon fibers, conductive metals, conductive metal fibers, or combinations thereof.

According to the disclosed embodiments, the casing 600 has a slit 611 that forms an opening in the casing material. The dimensions of the slit 611 are determined based on the size and number of radiating elements 621 in an active antenna array 620 as discussed above with respect to FIG. 4. The radiating elements 621 are disposed corresponding to the slit 611 opening. Therefore, the radiating elements 621 are not covered by the material of the casing 610. Thus, millimeter-wave signals are able to freely radiate through the opening of the slit 611.

It is important to note that these embodiments are only examples of the many advantageous uses of the innovative teachings herein. Specifically, the innovative teachings disclosed herein can be adapted in any type of consumer electronic device where reception and transmission of millimeter wave signals is needed. Moreover, some statements may apply to some inventive features but not to others. In general, unless otherwise indicated, it is to be understood that singular elements may be in plural and vice versa with no loss of generality.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. An millimeter-wave active antenna array mounting apparatus, comprising:
a casing having at least one slit, wherein the casing is made of a radiation energy blocking material; and
a millimeter-wave active antenna array configured to radiate millimeter-wave signals, wherein radiating elements of the millimeter-wave active antenna array are disposed corresponding to an opening of the at least one slit, thereby enabling an efficient radiation of the millimeter-wave signals through the casing.

2. The apparatus of claim 1, wherein the millimeter-wave active antenna array is mounted on a substrate of a radio frequency (RF) module, wherein the substrate is attached to an inner surface of the casing.

3. The apparatus of claim 1, wherein the substrate is attached to the inner surface by means of an adhesive material having thermal insulation properties.

4. The apparatus of claim 2, wherein the substrate of the RF module further includes a radio frequency (RF) circuitry configured to control and activate the millimeter-wave active antenna array.

5. The apparatus of claim 1, wherein the radiation energy blocking material includes at least one of carbon fiber, conductive metal, and conductive metal fiber.

6. The apparatus of claim 1, wherein the distance between radiating elements is between a half wavelength and a full wavelength of a millimeter-wave signal.

7. The apparatus of claim 1, wherein the width of the slit is up to 1 millimeter.

8. The apparatus of claim 3, wherein the radiating elements of the millimeter-wave active antenna array are fabricated on the substrate of the RF module.

9. The apparatus of claim 3, wherein the substrate of the RF module is any one of:
a printed circuit board (PCB) and a low temperature co-fired ceramic (LTCC),

10. The apparatus of claim 4, wherein the millimeter-wave active antenna array is an array of phased-array antennas.

11. The apparatus of claim 10, wherein the RF circuitry is further configured to control the phase per antenna in order to establish a beam-forming operation for the phased-array antenna.

12. The apparatus of claim 1, wherein the millimeter-wave active antenna array is a triple-band antenna.

13. The apparatus of claim 1, wherein the apparatus is disposed in a lid of a computing device.

14. The apparatus of claim 13, wherein the computing device is any one of a laptop computer, a notebook computer, and an ultrabook computer.

15. The apparatus of claim 1, wherein the apparatus is disposed in at least one of: a front panel and a back panel of a handled device.

16. The apparatus of claim 15, wherein the handled device is any one of: a mobile phone, a smart phone, and a tablet computer.
